(19) United States
(12) Patent Application Publication
(10) Pub. No.: US 2005/0129937 A1
(43) Pub. Date: Jun. 16, 2005

(54) Antimicrobial web for application to a surface

(75) Inventors: David L. Patton, Webster, NY (US); Richard W. Wien, Pittsford, NY (US); Carl A. Testa, Rochester, NY (US); Jacob L. Pietruszewski, Penfield, NY (US); Joseph F. Bringley, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/737,346

(22) Filed: Dec. 16, 2003

(51) Int. Cl. B32B 7/12

(52) U.S. Cl. 428/354; 428/343

(57) ABSTRACT

A flexible support layer having a first side and a second side, a flexible antimicrobial layer adjacent the first side of the support layer, and a flexible adhesive layer adjacent the second side of the support layer

### CROSS REFERENCE TO RELATED APPLICATIONS

Reference is made to commonly assigned, copending applications U.S. Ser. No. ______ (docket 87305) entitled ANTIMICROBIAL ARTICLE WITH DIFFUSION CONTROL LAYER by Bringley et al., and U.S. Ser. No. ______(Docket 87099) entitled ANTIMICROBIAL COMPOSITION by Bringley, et al. filed concurrently herewith.

### FIELD OF THE INVENTION

The present invention relates to a medium containing a controlled release antimicrobial material and/or that changes visual appearance as the material reaches a predetermined state. The medium also has an adhesive layer so it can be adhered to a surface such as a counter top.

### BACKGROUND OF THE INVENTION

In recent years people have become very concerned about exposure to the hazards of bacterial contamination. For example, exposure to certain strains of Eschericia coli through the ingestion of under cooked beef can have fatal consequences. Exposure to Salmonella enteritidis through contact with unwashed poultry can cause severe nausea and exposure to Staphylococcus aureus, Klebsiella pneumoniae, yeast (Candida albicans) can cause skin infections. In some instances bacterial contamination alters the taste of the food or drink or makes the food unappetizing. With the increased concern by consumers, manufacturers have started to produce products having antimicrobial properties. The most common antimicrobial used in many of these products is triclosan. Triclosan has proven to be effective only under certain conditions and in a limited number of products and does not kill a wide range of bacteria. It also lacks thermal stability, which causes it to leach out of rubber and rubber-like materials at higher temperatures.

In the area of food preparation, counter tops, table and cabinets are made using high-pressure laminates as discussed in U.S. Pat. No. 6,248,342. When used in food preparation areas, high-pressure laminates often come in contact with food and are a breeding ground for bacteria, fungi, and other microorganisms. Therefore, attempts have been made to develop high-pressure laminates having antimicrobial properties. For example, the organic compound triclosan has been incorporated in countertops in an attempt to provide a surface having antimicrobial properties. However, microorganisms can develop resistance to organic compounds such as triclosan. Moreover, the antimicrobial effects of triclosan decline over time as triclosan leaches out from the surface of the substrate, and there is no visual indication of the decline of the effectiveness. Because laminated countertops are an integral part of the cabinet, they are expensive to replace. In addition, triclosan is believed to cause skin irritation. Furthermore, triclosan is believed to generate dioxin when burned, creating disposal problems.

Nobel metal ions such as silver and gold ions are known for their anti-microbial activities and have been used in medical care for many years to prevent and treat infection.

Patents U.S. Pat. No. 5,556,699 and U.S. Pat. No. 6,436,422 disclose antibiotic materials containing zeolites for use as materials for packaging foods, medical equipments and accessories. U.S. Pat. No. 6,555,599 discloses an antimicrobial vulcanized EPDM rubber-containing article having sufficient antimicrobial activity and structural integrity to withstand repeated use without losing either antimicrobial power or modulus strength.

There is a problem in that antimicrobial films may quickly be depleted of antimicrobial active materials and become inert or non-functional. Depletion results from rapid diffusion of the active materials into the biological environment with which they are in contact. There is a further problem in that it is heretofore impossible to distinguish a depleted or inactive film from a working film using common human senses such as sight, smell or touch. Thus, users are unable to determine if a surface is antimicrobially safe for continued operation. When surface such as countertops lose this effectiveness in preventing bacterial growth, they are expensive and difficult to replace.

### PROBLEM TO BE SOLVED BY THE INVENTION

There remains a need to provide a perceivable indication to the user that the antimicrobial material is depleted or has worn away, thus prompting the user that the film needs to be replaced. The film also can be easily applied to a surface such as a countertop or other work surface and easily removed when the antimicrobial properties have been depleted.

### SUMMARY OF THE INVENTION

In accordance with one aspect of the present invention, there is provided a flexible multi-layer medium comprising:

a flexible support layer having a first side and a second side;

a flexible antimicrobial layer adjacent the first side of the support layer; and

a flexible adhesive layer adjacent the second side of the support layer.

In accordance with another aspect of the present invention there is provided a multi-layer medium comprising:

a support layer having a first side and a second side;

a antimicrobial layer adjacent the first side of the support layer, the antimicrobial layer having an indicating means for providing a visual indication of the effectiveness of the antimicrobial layer; and

an adhesive layer adjacent the second side of the support layer.

In accordance with yet another aspect of the present invention, there is provided an antimicrobial medium having a visual indicator for indicating the loss of effectiveness of the antimicrobial medium.

In yet still another aspect of the present invention, there is provided a multi-layer medium comprising:

a support layer having a first side and a second side;

a antimicrobial layer adjacent the first side of the support layer having controlled release of the active antimicrobial ingredient in the antimicrobial layer, and

an adhesive layer adjacent the second side of the support layer.

In accordance with still another aspect of the present invention, there is provided an antimicrobial material for detecting exposure to a pathogen, comprising an antimicrobial metal ion exchange material which is exchanged with at least one colored metal ion or colored metal ion complex.

These and other aspects, objects, features and advantages of the present invention will be more clearly understood and appreciated from a review of the following detailed description of the preferred embodiments and appended claims, and by reference to the accompanying drawings.

### DESCRIPTION OF THE DRAWINGS

In the detailed description of the preferred embodiments of the invention presented below, reference is made to the accompanying drawings in which:

FIG. 1 illustrates a cross section of an antimicrobial multilayer medium made in accordance with the present invention;

FIG. 2 illustrates a cross section of another embodiment of the multilayer medium made in accordance with the present invention;

FIG. 3 is a schematic of the multilayer medium of FIG. 1 attached to the surface such as a countertop in accordance with the present invention;

FIG. 4 illustrates a cross section of yet another embodiment of the multilayer medium of FIG. 1 made in accordance with the present invention;

FIG. 5 is a schematic illustrating a plurality or sheets of the multilayer medium of FIG. 1 made in accordance with the present invention;

FIG. 6 is a schematic of the multilayer medium of FIG. 1 being attached to a curved surface such as a scale in accordance with the present invention; and

FIG. 7 is a schematic of yet another embodiment of the multilayer medium of FIG. 1 being formed to fit the curved surface such as the inside of a cylinder in accordance with the present invention.

### DESCRIPTION OF THE PREFERRED EMBODIMENT

Referring to FIG. 1, there is illustrated a cross-sectional view of an antimicrobial multilayer medium 5, which in the embodiment illustrated, comprises a support layer 10 with an antimicrobial layer 15 coated on the top surface 18 of the support layer 10 with an adhesive layer 20 coated on the bottom surface 22 of the support layer 10. The support layer 10 can be a flexible substrate, which in the embodiment illustrated, has a thickness “x” of between 0.025 millimeters and 5.0 millimeters. In the embodiment illustrated, the thickness x is about 0.125 millimeters. It is, of course, to be understood that thickness of layer 10 may be varied as appropriate. The antimicrobial multilayer medium 5 may be made as a web (not shown) which is described later. Examples of supports useful for practice of the invention are resin-coated paper, paper, polyesters, or micro porous materials such as polyethylene polymer-containing material sold by PPG Industries, Inc., Pittsburgh, Pa. under the trade name of Teslin®, Tyvek® synthetic paper (DuPont Corp.), and OPPalytes® films (Mobil Chemical Co.) and other composite films listed in U.S. Pat. No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683; and 5,888,714, the disclosures of which are hereby incorporated by reference. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof; polyimides; polyamides; polycarbonates; polystyrene; polyolefins, such as polyethylene or polypropylene; polysulfones; polyacrylates; polyether imides; and mixtures thereof. The papers listed above include a broad range of papers from high end papers, such as photographic paper, to low end papers, such as newsprint. Another example of supports useful for practice of the invention are fabrics such as wools, cotton, polyesters, etc. The multilayer medium 5 may be, for example, in the form of a web or a sheet.

The antimicrobial active material of antimicrobial layer 15 may be selected from a wide range of known antibiotics and antimicrobials. An antimicrobial material may comprise an antimicrobial ion, molecule and/or compound, metal ion exchange materials exchanged or loaded with antimicrobial ions, molecules and/or compounds, ion exchange polymers and/or ion exchange latexes, exchanged or loaded with antimicrobial ions, molecules and/or compounds. Suitable materials are discussed in “Active Packaging of Food Applications” A. L. Brody, E. R. Strupinsky and L. R. Kline, Technomic Publishing Company, Inc. Pennsylvania (2001). Examples of antimicrobial agents suitable for practice of the invention include benzoic acid, sorbic acid, nisin, thymol, allicin, peroxides, imazalil, triclosan, benomyl, metal-ion release agents, metal colloids, anhydrides, and organic quaternary ammonium salts. Preferred antimicrobial reagents are metal ion exchange reagents such as silver sodium zirconium phosphate, silver zeolite, or silver ion exchange resin which are commercially available. The antimicrobial layer 15 generally has a thickness “y” of between 0.1 microns and 100 microns, preferably in the range of 1.0 and 25 microns. In the embodiment illustrated the thickness “y” is about 5 microns.

The adhesive used to form the adhesive layer 20 is typical of the adhesive layer found on the back shelving papers such as a reposition adhesive such as the adhesive used in 3M™ Scotch® 859 Removable Mounting Squares and 3M™ Scotch® Repositionable Glue Tape 928-100.

In another embodiment of the antimicrobial multilayer medium 5, the adhesive layer 20 may be a flexible static-cling vinyl such as Trans-Flex-Cast commercially available from Transilwrap Co., Inc., 9201 W. Belmont Ave., Franklin Park, Ill.

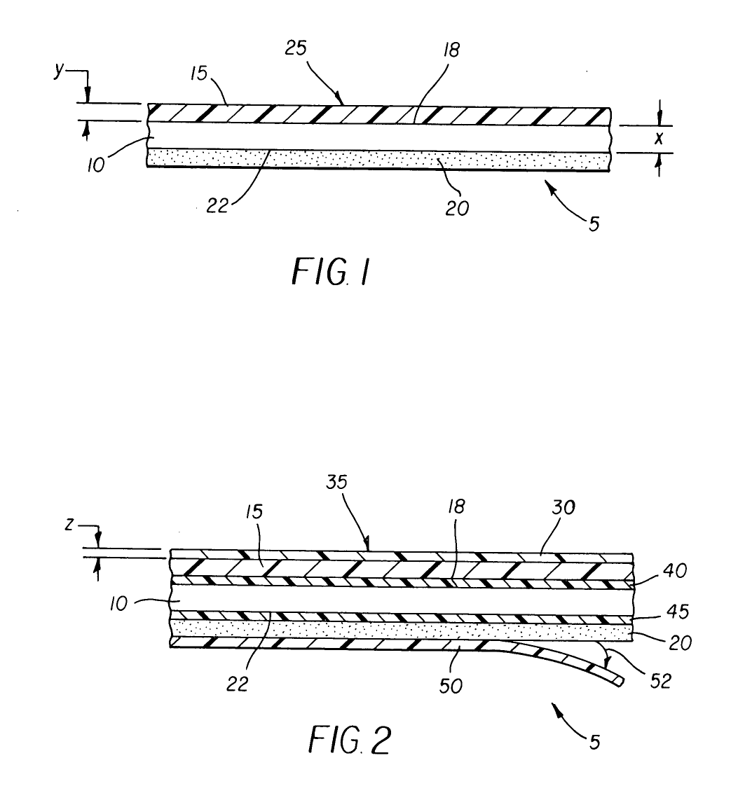

A second embodiment of the antimicrobial multilayer medium 5, made in accordance the present invention, is shown in FIG. 2. In this embodiment, a diffusion layer 30, having a thickness “z” of between 0.2 microns and 25 microns is used to control the amount of antimicrobial material reaching the outer surface 35 of the multilayer medium 5 is placed over the antimicrobial layer 15. Diffusion control layers suitable for the practice of the invention are described in U.S. application Ser. No. ______, (docket 87,099) entitled “Antimicrobial Silver containing article having controlled silver ion activity” by Joseph F. Bringley concurrently filed with this application. The antimicrobial material comprises, for example, a silver ion that travels from antimicrobial layer 15 through the diffusion layer 30 to the outer surface 35 of the multilayer medium 5 where the antimicrobial material stops or retards the growth of microbes. As the antimicrobial is depleted on the outer surface 35, more antimicrobial travels through the diffusion layer 30.

Depending upon the material chosen for the support layer, an additional layer called a subbing layer 40 may be coated on the top surface 18 of the support layer 10. The subbing layer 40 is used to insure proper adhesion of the antimicrobial layer 15 to the support layer 10. Likewise, a subbing layer 45 maybe coated on the bottom surface 22 of the support layer 10. The subbing layer 45 is used to insure proper adhesion of an adhesive layer 20 to the support layer 10. As previously discussed, depending on what material is used for the base 10, the subbing layer 45 may or may not be required. Preparing a support surface (hydrophobic) such as polyvinyl alcohol to accept a solvent cast polymer such as cellulose triacetate would require chemical and/or an interlayer coating (subbing layer) to improve adhesion. An example of this could be found in photographic patent literature where gelatin based hydrophilic photographic materials are commonly attached to hydrophobic supports such as polyethylene terephthalate. In the embodiment illustrated, an optional peelable protective release layer 50 is provided over adhesive layer 20 for protecting the adhesive layer 20 until it is to be used for securing the multilayer medium 5 to a surface. Preferred protective release materials include polyester, cellulose paper, and biaxially oriented polyolefin. The release layer 50 is peeled off the adhesive layer 20 as indicated by arrow 52 whereby the multilayer medium 5 is secured to the desired surface.

A web (not shown) of the antimicrobial medium 5 can be made by several possible methods. In one embodiment, the antimicrobial web is made by coating the surface 18 of a plastic, paper or fabric support 10 with a polymeric layer containing one or more antimicrobial compounds. The antimicrobial is typically dispersed or dissolved in a medium or solvent. The medium or solvent may contain a binder to allow the antimicrobial to adhere to the support 10 and may contain other addenda such as coating aids, surfactants, plasticizers, etc. to aid the coating process. The coating may be applied by painting, spraying or casting. It is preferred to apply the coating via a solvent assisted process (aqueous or organic) such as blade, rod, knife or curtain coating. The antimicrobial web may also be made by extrusion, or coextrusion of polymeric layers such that at least one layer comprises an antimicrobial compound and the color indicating chemistry described below. The antimicrobial web may also be prepared by blow molding.

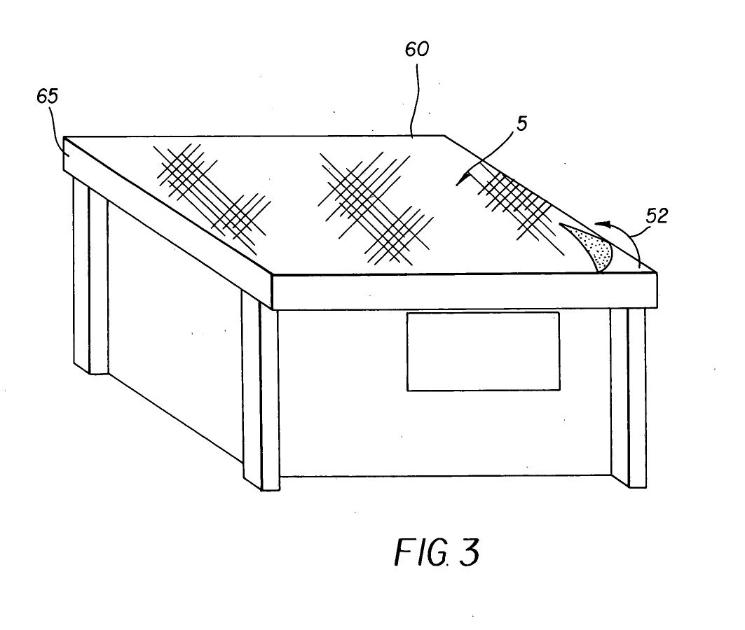

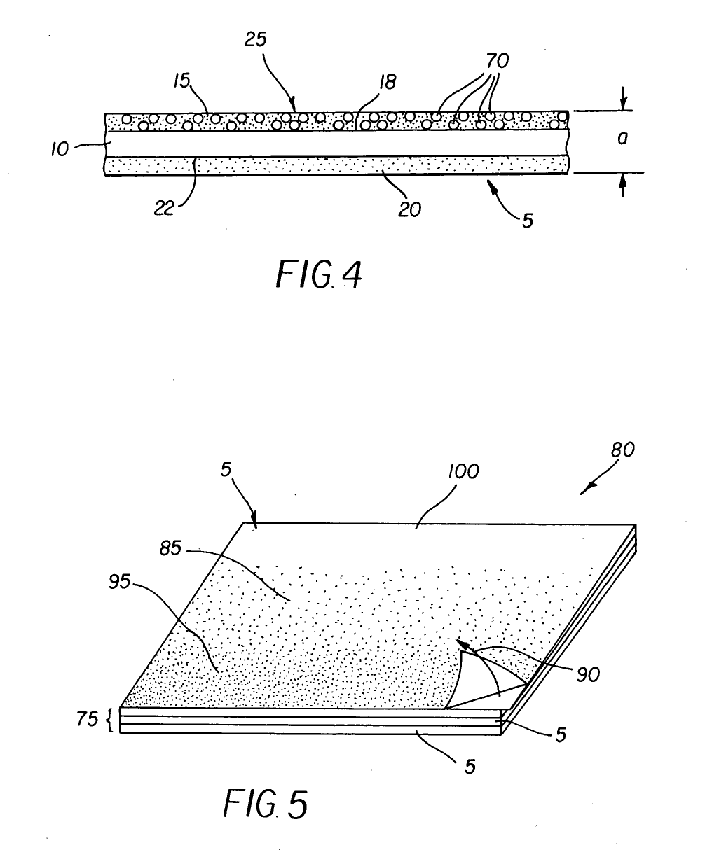

Now referring to FIG. 3, there is illustrated a sheet of multilayer medium 5 of FIG. 1 attached to a top surface 60 of a counter or table 65 in accordance with the present invention. The sheet of multilayer medium 5 is attached via the adhesive layer 20 previously described. In the particular embodiment illustrated, the support layer 10 is, for example, polyethylene, which provides the sheet of multilayer medium 5 with excellent wear characteristics. The sheet of multilayer medium 5 in this embodiment has a thickness “a” of between 0.025 millimeters and 6 millimeters (shown in FIG. 4) is applied to the top surface 60 by first peeling the protective release layer 50 from the adhesive layer 20 as previously described in FIG. 2. The sheet of multilayer medium 5 is then placed onto the surface in a fashion similar to applying adhesive backed shelf paper to a shelf. The multilayer medium 5 remains on the top surface 60 of the counter 65 until the antimicrobial material is substantially depleted or is substantially no longer effective at which point the sheet of multilayer medium 5 is peeled from the top surface 60 of the counter 65 and indicated by the arrow 52 and replaced with a new sheet of multilayer medium 5. The method for determining when the antimicrobial properties of the sheet of multilayer medium 5 have been depleted and are no longer effective and the sheet of multilayer medium 5 should be replaced is describe below in FIGS. 4 and 5.

Now referring to FIG. 4, there illustrates a cross section of yet another embodiment the multilayer medium 5 of FIG. 1 made in accordance with the present invention. In this embodiment, as the antimicrobial material in layer 15 is being depleted, the antimicrobial layer 15 changes its visual appearance as the effectiveness (shown in FIG. 5) of the antimicrobial material is reduced. In this manner, the user is prompted that the sheet of multilayer medium 5 may need to be replaced. Depending upon the antimicrobial material being utilized, a visual change, such as a color change upon depletion of the material, may be realized in a variety of ways. The color indicating chemistry 70 of the multilayer medium 5 may be contained within the antimicrobial layer 15 per FIG. 1, or in the diffusion layer 30 shown in FIG. 2, or in both. We discuss below multiple ways to achieve a color indicating change although the invention is not limited only to these methods. For example, but not limited to, the color may change from green to red or from white to black. Preferably, the color changes incrementally upon depletion (loss of effectiveness) of the antimicrobial material. Also the color change is preferably about equal or greater than a 0.2 change in optical density, and more preferably greater than a 0.5 change in optical density.

In a preferred embodiment, the multilayer medium 5 contains an antimicrobial material comprising a metal ion exchange material which is exchanged with at least one antimicrobial metal ion selected from silver, copper, gold, nickel or zinc, and is additionally exchanged with at least one colored metal ion, or colored metal ion complex. The colored metal ion or metal ion complex may be antimicrobial or may be inert. The colored metal ion or metal ion complex imparts color to the antimicrobial sheet and upon exposure to a biological medium, diffuses into the medium, and is depleted in the same manner that the antimicrobial metal ion is depleted. As the colored metal ion or colored metal-ion complex is depleted, the web changes color. The amount of exchanged colored metal ion or metal ion complex is determined such the rate of depletion of the colored metal ion is similar to the rate of depletion of the antimicrobial metal ion, and thus, the loss of color from the web indicates a loss of antimicrobial activity. In a further preferred embodiment, the antimicrobial material consists of metal ion exchanged zirconium phosphate, zeolite or other metal ion exchanged resin, which is exchanged with at least one antimicrobial metal ion selected from silver, copper, gold, nickel or zinc, and is additionally exchanged with at least one highly colored metal ion or metal ion complex. Colored metal ions or metal ion complexes suitable for practice of the invention are Cu(II), Co(II), Co(HII), Ni(II), Manganese ion, Cr(III), Fe(II), Fe(III), Ni(II) and metal ion complexes such as Co(NH₃)₆³⁺, Cu(NH₃)₄²⁺.

Alternatively, color indication can be provided in the diffusion control layer 30 shown in FIG. 2 by incorporating therein a colored material such as a dye which may diffuse from the layer when the sheet is exposed to a biological environment. In this case it is preferred that the colored material be soluble in water so that its diffusion rate can be used to approximate the depletion rate of the antimicrobial active material. The amount of dye to be incorporated into the diffusion layer 30 should be such as to impart clearly visible color to the sheet. The solubility of the dye, its rate of depletion from the diffusion layer 30, and the rate of depletion of the antimicrobial material from the web may be determined by one skilled in the art.

Another approach to providing color indication for the antimicrobial web is to incorporate a colorless, or colored, precursor material which then reacts with a diffusible species such as antimicrobial ions, to form a colored molecule or material, or a material of a different color than the precursor. In this manner, as more antimicrobial ions diffuse through the web, more dye is produced thus producing a visual color indication. In a preferred embodiment the dye precursor is contained in the diffusion control layer 30 and reacts with diffusing antimicrobial metal ions selected from silver, copper, gold, zinc and nickel to produce a colored material. A working example of the color indicating chemistry 70 is illustrated below in which a metalized dye is formed by reaction of a metal ion with the ligand, 2-methyl-5-hydroxy-8-(2-pyridylazo)-quinoline-3-carboxylic acid. The reaction forms a very highly colored dye having the stoichiometry M(ligand) or M(Ligand)₂. Examples of suitable metal ions are copper, zinc, cobalt and nickel.

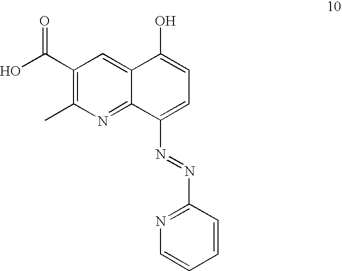

Now referring again to FIG. 5 still another embodiment of the present invention is illustrated. A plurality of antimicrobial sheets 75 is layered together to form a stack 80. As the effectiveness of the antimicrobial is depleted or reduced, the top surface 85, where the antimicrobial in now longer effective, changes color or light and darkness as indicated by the dark area 95. The area where the antimicrobial is still effective is indicated by the light area 100. When the antimicrobial is no longer effective, the top sheet of the multilayer medium 5 can now be removed by simply peeling away the top sheet of the multilayer medium 5 as indicated by the arrow 90 leaving a fresh antimicrobial sheet of the multilayer medium 5 on the surface.

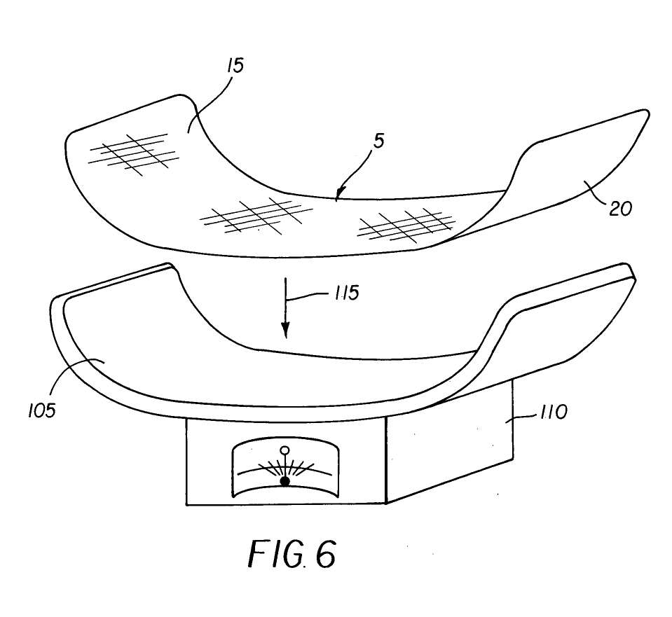

Now referring to FIG. 6, there is illustrated the sheet of the multilayer medium 5 being attached to a curved surface 105 for example of a scale 110. The flexibility of the sheet of the multilayer medium 5 allows it to conform to the curvature of the scale 110. The adhesive layer 20 attaches the sheet 5 securely to the curved surface 110. The sheet 5 is applied to the curved surface 105 by first peeling the protective release layer 50 from the adhesive layer 20 as previously shown in FIG. 2. The sheet of multilayer medium 5 is then placed onto the surface as indicated by arrow 115 in a fashion similar to applying adhesive backed shelf paper to a shelf.

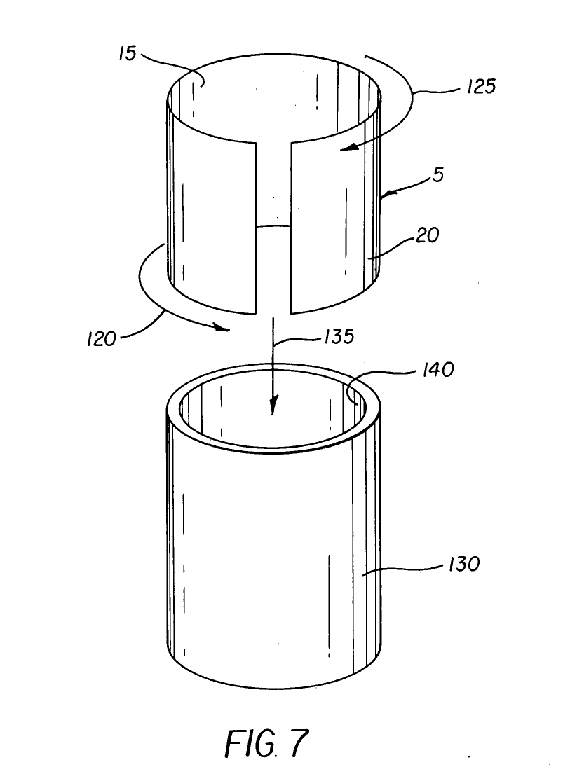

Yet another embodiment of the present invention is illustrated in FIG. 7. The sheet of multilayer medium 5 is formed as indicated by the arrows 120 and 125 to slide into the cylinder 130 as indicated by arrow 135. Once inside the cylinder 130, the sheet 5 flexes outward until it conforms to the inner surface 140 of the cylinder 130.

It is to be understood that various other changes and modifications may be made without departing from the scope of the present invention, the present invention being defined by the following claims.

Parts List:

5 multilayer medium
10 support layer
15 antimicrobial layer
18 top surface
20 adhesive layer
22 bottom surface
25 outer surface
30 diffusion layer
35 outer surface
40 subbing layer
45 subbing layer
50 release layer
52 arrow
55 sheet
60 top surface
65 counter top/table
70 color indicating chemistry
75 plurality of antimicrobial sheets
80 stack
85 top surface
90 arrow
95 dark area
100 light area
105 curved surface
110 scale
115 arrow
120 arrow
125 arrow
130 cylinder
135 arrow
140 inner surface

1. A flexible multi-layer medium comprising:
a flexible support layer having a first side and a second side;
a flexible antimicrobial layer adjacent said first side of said support layer; and
a flexible adhesive layer adjacent said second side of said support layer.

2. A medium according to claim 1 wherein said antimicrobial layer changes color as the effectiveness of said antimicrobial is reduced.

3. A medium according to claim 1 wherein said antimicrobial layer provides a controlled release of a antimicrobial material.

4. A medium according to claim 3 wherein said controlled release is accomplished by use of a diffusion layer placed over said antimicrobial layer.

5. A medium according to claim 3 wherein said antimicrobial material comprises an antimicrobial metal ion exchange material which is exchanged with at least one colored metal ion or colored metal ion complex.

6. A medium according to claim 5 wherein said antimicrobial metal ion is selected from one of the following:
silver
gold
copper
zinc
nickel

7. A medium according to claim 1 wherein a colored material is provided in said medium that has a diffusion rate substantially the same as the depletion rate of the active ingredient in said antimicrobial layer so that a visual indication will be provided as to the effectiveness of said active ingredient.

8. A medium according to claim 1 wherein the color change is about equal or greater than a 0.2 change in optical density.

9. A medium according to claim 8 where the color change is greater than a 0.5 change in optical density.

10. A medium according to claim 1 wherein the antimicrobial layer is made from one or more of the following antimicrobial compounds:
silver sodium zirconium phosphate
silver zeolite
or silver ion exchange resins, benzoic acid, sorbic acid, nisin, thymol, allicin, peroxides, imazalil, triclosan, benomyl, metal-ion release agents, metal colloids, anhydrides, and organic quaternary ammonium salts.

11. A medium according to claim 1 wherein the support layer is made from one or more of the following:
resin-coated paper
paper, polyesters
micro porous materials
polyethylene
plain paper
coated paper
synthetic paper
photographic paper support
melt-extrusion-coated paper
laminated paper
biaxially oriented polyolefin
polypropylene
glass
cellulose derivatives
polyesters.

12. A medium according to claim 1 wherein the adhesive layer is made from one or more of the following:
reposition adhesive
flexible static-cling vinyl.

13. A medium according to claim 1 wherein the diffusion layer comprises a dye which diffuses from the diffusion layer when the sheet is exposed to a biological environment.

14. A medium according to claim 1 wherein the antimicrobial layer has a thickness in the range of 0.01 μm to 100 μm.

15. A medium according to claim 1 where the thickness of said antimicrobial layer is about 5 μm.

16. A medium according to claim 1 wherein the support layer has a thickness in the range of 0.025 mm to 5 mm.

17. A medium according to claim 1 where the thickness of said support layer is about 0.125 mm.

18. A medium according to claim 4 wherein the diffusion layer has a thickness in the range of 0.2 μm to 25 μm.

19. A medium according to claim 4 where the thickness of said diffusion layer is about 5 μm.

20. A medium according to claim 1 further comprising a subbing layer provided between support layer and said antimicrobial layer for providing proper adhesion of the antimicrobial layer to said support layer.

21. A medium according to claim 1 wherein a removable protective layer is provided over said adhesive layer for protecting said adhesive layer until it can be secured to a receiving surface.

22. A multi-layer medium comprising:
a support layer having a first side and a second side;
a antimicrobial layer adjacent said first side of said support layer, said antimicrobial layer having an indicating means for providing a visual indication of the effectiveness of the antimicrobial layer; and
an adhesive layer adjacent said second side of said support layer.

23. A multi-layer medium according to claim 22 wherein said visual indication means comprises a change in color when the effectiveness of said antimicrobial is reduced.

24. A medium according to claim 22 wherein said antimicrobial layer provides a controlled release of a antimicrobial material.

25. A medium according to claim 24 wherein said controlled release is accomplished by use of a diffusion layer placed over said antimicrobial layer.

26. A medium according to claim 24 wherein said antimicrobial material comprises an antimicrobial metal ion which is exchanged with at least one colored metal ion or colored metal ion complex.

27. A medium according to claim 26 wherein said antimicrobial metal ion is selected from one of the following:
silver
gold
copper
zinc
nickel

28. A medium according to claim 22 wherein a colored material is provided in said medium that has a diffusion rate substantially the same as the depletion rate of the active ingredient in said antimicrobial layer so that a visual indication will be provided as to the effectiveness of said active ingredient.

29. A medium according to claim 23 wherein the color change is about equal or greater than a 0.2 change in optical density.

30. A medium according to claim 29 where the color change is greater than a 0.5 change in optical density.

31. A medium according to claim 22 wherein the antimicrobial layer is made from one or more of the following antimicrobial compounds:
silver sodium zirconium phosphate
silver zeolite
or silver ion exchange resins benzoic acid, sorbic acid, nisin, thymol, allicin, peroxides, imazalil, triclosan, benomyl, metal-ion release agents, metal colloids, anhydrides, and organic quaternary ammonium salts.

32. A medium according to claim 22 wherein the support layer is made from one or more of the following:
resin-coated paper
paper, polyesters
micro porous materials
polyethylene
plain paper
coated paper
synthetic paper
photographic paper support
melt-extrusion-coated paper
laminated paper
biaxially oriented polyolefin
polypropylene
glass
cellulose derivatives
polyesters.

33. A medium according to claim 22 wherein the adhesive layer is made from one or more of the following:
reposition adhesive
flexible static-cling vinyl.

34. A medium according to claim 25 wherein the diffusion layer comprises a dye which diffuses from the diffusion layer when the sheet is exposed to a biological environment.

35. A medium according to claim 22 wherein the antimicrobial layer has a thickness in the range of 0.01 μm to 100 μm.

36. A medium according to claim 22 where the thickness of said antimicrobial layer is about 5 μm.

37. A medium according to claim 22 wherein the support layer has a thickness in the range of 0.025 mm to 5 mm.

38. A medium according to claim 22 wherein the thickness of said support layer is about 0.125 mm.

39. A medium according to claim 26 wherein the diffusion layer has a thickness in the range of 0.2 μm to 25 μm.

40. A medium according to claim 26 where the thickness of said diffusion layer is about 5 μm.

41. A medium according to claim 22 further comprising a subbing layer provided between support layer and said antimicrobial layer for providing proper adhesion of the antimicrobial layer to said support layer.

42. A medium according to claim 22 wherein a removable protective layer is provided over said adhesive layer for protecting said adhesive layer until it can be secured to a receiving surface.

43. A antimicrobial medium having a visual indicator for indicating the loss of effectiveness of the antimicrobial medium.

44. A medium according to claim 43 wherein said antimicrobial medium changes color as the effectiveness of said antimicrobial is reduced.

45. A medium according to claim 43 wherein said antimicrobial medium provides a controlled release of a antimicrobial material.

46. A medium according to claim 45 wherein said controlled release is accomplished by use of a diffusion layer placed over said antimicrobial layer.

47. A medium according to claim 46 wherein said antimicrobial material comprises a antimicrobial metal ion which is exchanged with at least one colored metal ion or colored metal ion complex.

48. A medium according to claim 46 wherein said antimicrobial metal ion is selected from one of the following:
silver
gold
copper
zinc
nickel

49. A medium according to claim 43 wherein a colored material is provided in said medium that has a diffusion rate substantially the same as the depletion rate of the active ingredient in said antimicrobial medium so that a visual indication will be provided as to the effectiveness of said active ingredient.

50. A medium according to claim 43 wherein the color change is about equal or greater than a 0.2 change in optical density.

51. A medium according to claim 50 where the color change is greater than a 0.5 change in optical density.

52. A medium according to claim 43 wherein the antimicrobial medium is made from one or more of the following antimicrobial compounds:
silver sodium zirconium phosphate
silver zeolite
or silver ion exchange resins, benzoic acid, sorbic acid, nisin, thymol, allicin, peroxides, imazalil, triclosan, benomyl, metal-ion release agents, metal colloids, anhydrides, and organic quaternary ammonium salts.

53. A medium according to claim 43 wherein the antimicrobial medium has a thickness in the range of 0.01 μm to 100 μm.

54. A medium according to claim 43 where the thickness of said antimicrobial medium is about 5 μm.

55. A medium according to claim 43.

56. A multi-layer medium comprising:
a support layer having a first side and a second side;
a antimicrobial layer adjacent said first side of said support layer having controlled release of the active antimicrobial ingredient in said antimicrobial layer, and
an adhesive layer adjacent said second side of said support layer.

57. A medium according to claim 56 wherein said antimicrobial layer changes color as the effectiveness of said antimicrobial is reduced.

58. A medium according to claim 56 wherein said antimicrobial layer provides a controlled release of an antimicrobial material.

59. A medium according to claim 57 wherein said controlled release is accomplished by use of a diffusion layer placed over said antimicrobial layer.

60. A medium according to claim 57 wherein said antimicrobial material comprises a antimicrobial metal ion which is exchanged with at least one colored metal ion or colored metal ion complex.

61. A medium according to claim 60 wherein said antimicrobial metal ion is selected from one of the following:
silver
gold
copper
zinc
nickel

62. A medium according to claim 56 wherein a colored material is provided in said medium that has a diffusion rate substantially the same as the depletion rate of the active ingredient in said antimicrobial layer so that a visual indication will be provided as to the effectiveness of said active ingredient.

63. A medium according to claim 56 wherein the color change is about equal or greater than a 0.2 change in optical density.

64. A medium according to claim 63 where the color change is greater than a 0.5 change in optical density.

65. A medium according to claim 56 wherein the antimicrobial layer is made from one or more of the following antimicrobial metal ion compounds:
silver sodium zirconium phosphate
silver zeolite
or silver ion exchange resins, benzoic acid, sorbic acid, nisin, thymol, allicin, peroxides, imazalil, triclosan, benomyl, metal-ion release agents, metal colloids, anhydrides, and organic quaternary ammonium salts.

66. A medium according to claim 56 wherein the support layer is made from one or more of the following:
resin-coated paper
paper, polyesters
micro porous materials
polyethylene
plain paper
coated paper
synthetic paper
photographic paper support
melt-extrusion-coated paper
laminated paper
biaxially oriented polyolefin
polypropylene
glass
cellulose derivatives
polyesters.

67. A medium according to claim 56 wherein the adhesive layer is made from one or more of the following:
reposition adhesive
flexible static-cling vinyl.

68. A medium according to claim 56 wherein the diffusion layer comprises a dye which diffuses from the diffusion layer when the sheet is exposed to a biological environment.

69. A medium according to claim 56 wherein the antimicrobial layer has a thickness in the range of 0.1 μm to 25 μm.

70. A medium according to claim 56 wherein the thickness of said antimicrobial layer is about 5 μm.

71. A medium according to claim 56 wherein the support layer has a thickness in the range of 0.025 mm to 5 mm.

72. A medium according to claim 56 where the thickness of said support layer is about 0.125 mm.

73. A medium according to claim 59 wherein the diffusion layer has a thickness in the range of 0.2 μm to 25 μm.

74. A medium according to claim 59 where the thickness of said diffusion layer is about 5 μm.

75. A medium according to claim 56 further comprising a subbing layer provided between support layer and said antimicrobial layer for providing proper adhesion of the antimicrobial layer to said support layer.

76. A medium according to claim 56 wherein a removable protective layer is provided over said adhesive layer for protecting said adhesive layer until it can be secured to a receiving surface.

77. An antimicrobial material for detecting exposure to a pathogen, comprising an antimicrobial metal ion exchange material which is exchanged with at least one colored metal ion or colored metal ion complex.

78. An antimicrobial material according to claim 77 wherein said color of said material indicates the effectiveness of said antimicrobial material.

79. An antimicrobial material according to claim 77 wherein said antimicrobial material provides a controlled release of a antimicrobial material.

80. An antimicrobial material according to claim 79 wherein said controlled release is accomplished by use of a diffusion layer placed over said antimicrobial layer.

81. An antimicrobial material according to claim 77 wherein said antimicrobial metal ion is selected from one of the following:
silver
gold
copper
zinc
nickel

82. An antimicrobial material according to claim 77 wherein the antimicrobial material comprises one or more of the following antimicrobial compounds:
silver sodium zirconium phosphate
silver zeolite
or silver ion exchange resins, benzoic acid, sorbic acid, nisin, thymol, allicin, peroxides, imazalil, triclosan, benomyl, metal-ion release agents, metal colloids, anhydrides, and organic quaternary ammonium salts.

83. An antimicrobial material according to claim 77 wherein said material includes a support layer made from one or more of the following:
resin-coated paper
paper, polyesters
micro porous materials
polyethylene
plain paper
coated paper
synthetic paper
photographic paper support
melt-extrusion-coated paper
laminated paper
biaxially oriented polyolefin
polypropylene
glass
cellulose derivatives
polyesters.

84. An antimicrobial material according to claim 77 wherein an adhesive layer is provided which is made from one or more of the following:
reposition adhesive
flexible static-cling vinyl.

85. A plurality of multi-layer sheets layered together to form a stack of flexible multi-layer medium comprising: a flexible support layer having a first side and a second side; a flexible antimicrobial layer adjacent said first side of said support layer; and a flexible adhesive layer adjacent said second side of said support layer.

86. A flexible multi-layer medium comprising:
a flexible support layer having a first side and a second side;
a flexible antimicrobial layer adjacent said first side of said support layer; and
a flexible adhesive layer adjacent said second side of said support layer that can be configured to a non flat surface.

87. A method of attaching the flexible multi-layer medium of claim 1 is attached to a surface via the adhesive layer.

88. A method of claim 87 wherein the antimicrobial material is released in a controlled fashion by use of a diffusion layer placed over said antimicrobial layer.

89. A method of claim 87 wherein the antimicrobial material is substantially depleted or is substantially no longer effective and is peeled from the surface and replaced with a new sheet of multilayer medium.

90. The method of claim 87 wherein the antimicrobial material for determining when the antimicrobial properties of the sheet of multilayer medium changes color as the effectiveness of said antimicrobial is reduced.
